(19) United States
(12) Patent Application Publication
(10) Pub. No.: US 2012/0066500 A1
(43) Pub. Date: Mar. 15, 2012

(54) Method of Time Synchronization Communication

(75) Inventors: Sriram ANANTHASUBRAMANIAN, Bangalore (IN); Ba Chandramohan, Bangalore (IN); Mathews Emmanuel, Bangalore (IN); Ramesh Marimuthu, Bangalore (IN); Sakthivel Sankara Gounder, Bangalore (IN)

(73) Assignee: Siemens Aktiengesellschaft, Munchen (DE)

(21) Appl. No.: 13/178,313

(22) Filed: Jul. 7, 2011

(30) Foreign Application Priority Data
Jul. 7, 2010 (EP) 10168722

(51) Int. Cl. H04L 9/32

(52) U.S. Cl. 713/171

(57) ABSTRACT

A method for sending a public key from a client to a time server for encrypting a response message to the client as part of a time synchronization communication to providing a safe way of performing time synchronization communication, where the method comprises sharing the public key of the time server with the client prior to the time synchronization communication, sending an encrypted public key of the client to the time server, and decrypting the encrypted public key of the client using the private key of the time server by the time server.

### BACKGROUND OF THE INVENTION

1. Field of the Invention

The present invention relates to time synchronization communication and, more particularly, to a method of communication between a client and a time server in time synchronization communication.

2. Description of the Related Art

In a distributed control system or network, it is possible that the main control system, the deployment configurations and the sub-components are installed at different locations, or even in different time zones. The users, for example, the Human Machine Interface (HMI) operators or engineers should see and access the runtime process data and values, alarms, diagnostic information or any kind of data in a plant with accurate timestamp so that the sequence of events happening in the plant can be monitored, controlled and archived from any devices so that appropriate actions can be taken. In a process automation environment, time synchronization is applicable for synchronizing processes, controlling complex sequences, logging and documenting sequences, validating processes, analyzing processes and also analyzing the causes and effects of events.

In a time synchronization communication, one system component provides time information to all the other components in the network so that all the components in the network are synchronized and run with a common time information. The time information can either be distributed by a time server, e.g., a time master, or can be requested by the client, e.g., time slaves. If any unintended sources manipulate the timestamps in the network or if they distribute false timestamps, it will lead to a wrong time in the plant and it will endanger the plant operations. Consequently, there is a need for secure time synchronization in the plant. It also means that since there is no continuous connection, it is easier for someone to attempt unauthorized communication by simply sending a message to a port that is known to be waiting for replies to a time request or for replies for any given process running on the host computer. In addition, it is possible for an intruder to send a manipulated request to a time server. It is also possible to restrict certain internet protocol (IP) addresses to identify the sender and discard the requests received, if not from the desired sender. However, an intruder will be able to manipulate the packets including IP headers to send a packet with actual sender and receiver from a different machine.

### SUMMARY OF THE INVENTION

It is therefore an object of the present invention to provide early detection of an unauthorized access in a time synchronization communication between a client and a time server.

This and other objects and advantages are achieved by a method for sending a public key from a client to a time server for encrypting a response message to the client as part of a time synchronization communication by providing the public key of the time server to the client independently. Here, the public key is sent prior to the start of initiation of a time synchronization communication and an encrypted public key of the client is sent to the time server, where the public key of the client is encrypted using the public key of the time server to form the encrypted public key and the time server further decrypts the encrypted public key of the client using the private key of the time server.

The object of the invention is further achieved by a method for a time synchronization communication between a client and a time server. The method comprises sending a public key from the client to the time server by the above-described method and also comprises sending a session key response message with a session key by the time server to the client, where the session key is encrypted using the public key of the client and further signed with the private key of the time server. At the client side, the method further comprises verifying the signed session key using the public key of the time server and decrypting the session key using the private key of the client. The client then generates a secured hash value for a time request using the session key received and sends the time request message and the secured hash value to the time server. At the time server, the time request message is verified based on the secured hash value and the session key, and based on the verification a time response is sent from the time server to the client, where the time response comprises information on a time for performing time synchronization.

The underlying idea is to initially provide the public key of the time server with the client independently of and prior to the time synchronization communication. The time or sequence of providing the public key of the time server to the client has no binding to the time synchronization communication as such. For example, in a networked environment, the public key of the time server is provided only with the authorized clients. This provides security, ensuring the accessibility of the public key of the time server to only authorized users. During a synchronization communication, the public key of the client is encrypted for security and sent to the time server. The public key of the client can only be decrypted by the time server using the private key of the time server thereby avoiding any unauthorized access resulting in additional security. Currently, in time synchronization communication, for example, using a Network Time Protocol (NTP) the public key of the time server is provided to the client by an appropriate response message by the time server for a formal request message by the client. Also, the public key of the client is sent to the time server without any encryption. Hence, the public key of the time server and the public key of the client are open to an attack or unauthorized access by a third party. The step of providing the public key of the time server to the client and sending of the encrypted public key of the client to the time server occurs at the beginning of a time synchronization communication. Consequently, early detection of an unauthorized access is possible. In accordance with the present invention, the public key of the time server is provided to only the authorized clients. As a result, a third party who is trying to access the time server during a time synchronization communication is considered as an intruder or an unauthorized user. Additionally, the encrypted public key of the client can only be decrypted by the private key of the time server. As a result, any unsuccessful decryption at the time server can also be considered as a detection of an unauthorized access.

In a preferred embodiment, providing the public key of the time server with the client involves pre-installing the public key in the client prior to the time synchronization communication. If the public key is exchanged every time during the initiation of a time synchronization communication, then there is a high possibility of exposing the public key for unauthorized access to a third party. By pre-installing the public key of the time server in clients, the above risk can be avoided.

In an alternative embodiment, providing the public key of the time server to the client involves providing the public key from a secure store to the client, prior to the time synchronization communication. The secure store is a trusted store in the network at which the public key of the server could be stored initially and later provided to the client. Since the store is a secured store, the store can be configured to provide the public key only to the authorized clients or could be configured to reject requests from unauthorized clients or could be configured to perform both functions.

In an alternative embodiment, the method further comprises sending a signed public key of the client to the time server at which the public key of the client is signed using the private key of the client to form the signed public key, and at the time server, verifying the signed public key of the client using the public key of the client that is decrypted by the time server. As a result, additional security is provided for the time synchronization communication. Since the plain version of the public key of the client is already decrypted and is available with the time server, successful verification of the signed public key of the client with the plain public key of the client ensures that the public keys are not manipulated and the communication is part of an authorized time synchronization communication.

In accordance with the disclosed embodiments, the public and private keys are generated in pairs. As a result, signing the public key of the client with the private key of the client enables the verification of a signed message with only the corresponding opposite pair of keys. The method of decrypting an encrypted message also makes use of the corresponding opposite pair of keys. As a result, successful performance of corresponding operations are allowed by the client and the time server only if they possess the corresponding keys.

In an alternative embodiment, an encrypted public key of the client is sent to the time server as part of a time synchronization communication according to a Network Time Protocol (NTP) standard, where encrypted public key of the client is included in a value field associated with an NTP extension field of an NTP header. The NTP standard has been established to facilitate time synchronizations in network devices. The NTP standard provides a way for all clocks in computers on a network to be synchronized. Since the value field is already provided in an extension field of an NTP header in an NTP protocol stack, the same field can be used to store and send the encrypted public key avoiding any creation of the new field.

In an alternative embodiment, the signed public key of the client is sent to the time server as part of a time synchronization communication according to the NTP standard, where the signed public key of the client is included in a signature field associated with an NTP extension field of the NTP header. Here, the signature field is already provided in an extension field of an NTP header in the NTP protocol stack. As a result, the same field can be used to store and send the signed public key avoiding any creation of the new field.

In an alternative embodiment, an encrypted session key is sent to the client by the time server as part of a time synchronization communication according to the NTP standard, where an encrypted session key is included in a value field associated with an NTP extension field of the NTP header. In another alternative embodiment, the signed encrypted session key is sent to the client by the time server as part of a time synchronization communication according to the NTP standard, where the signed encrypted session key is included in a signature field associated with an NTP extension field of the NTP header. In general, session keys are used for identifying and associating all messages of one communication session, thereby ensuring data integrity. The session keys are used to generate a secured hash value by the client, which further is cross checked at the time server for data integrity in a time synchronization communication between the client and the time server. Here, the value field and the signature field are already provided in an extension field of an NTP header in the NTP protocol stack. As a result, the same fields can be used to store and send the encrypted public key and the signed encrypted public key respectively, thus avoiding any creation of the new field.

In another alternative embodiment, the client is configured to send the time request message at a plurality of times to the time server for time synchronization during a time synchronization communication. The plurality of time requests enables the client to seek time for a constant update of the time information, which might be very critical for its operations.

In another alternative embodiment, providing the public key of the time server to the client involves sending the public key by the time server to the client for a single time before sending the time request message by the client to the time server in a time synchronization communication. Here, the sending of the public key by the time server need not be during an NTP communication or NTP packet exchange. Providing the public key for a single time ensures that the public key is not repeatedly sent during a time synchronization communication, thereby not exposing the public key to a third party for any continuous manipulation. For example, at the engineering time or the installation time of the time server and the client, the public key of the time server can be sent to the client. After the client receives the public key, the public key can be permanently stored in the client for further communication. Here, the public key is sent to the clients at the engineering time and not at the time of time synchronization communication. Consequently, it is unlikely that the third party will notice or listen to the transfer of the public key.

In an alternative embodiment, the private key and public key of the time server and client is generated by a key generator. Here, a separate key generator can be used for the generation of the private key and public key of the time server and client. The private and public keys are generally generated in pairs so that both have common associating parameters, which can be used for encryption and decryption and signing and verification.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described hereinafter with reference to illustrated embodiments shown in the accompanying drawings, in which:

FIG. 1 is a schematic block diagram of a network, in which time synchronization in accordance with the invention is performed, usually using a time clock;

FIG. 2 is a schematic block diagram of a process flow between the client and the time server during time synchronization communication for sending a public key of a client from the client to a time server in accordance with the invention;

FIG. 3 is a schematic block diagram of a process flow between a client and a time server during time synchronization communication for additionally confirming the authenticity of the client in accordance with an embodiment of the invention; and

FIG. 4 is a flow chart of a method for providing time synchronization between a client and a time server in accordance with an embodiment of the invention using an Network Time Protocol (NTP) protocol.

### DETAILED DESCRIPTION OF THE PRESENTLY PREFERRED EMBODIMENTS

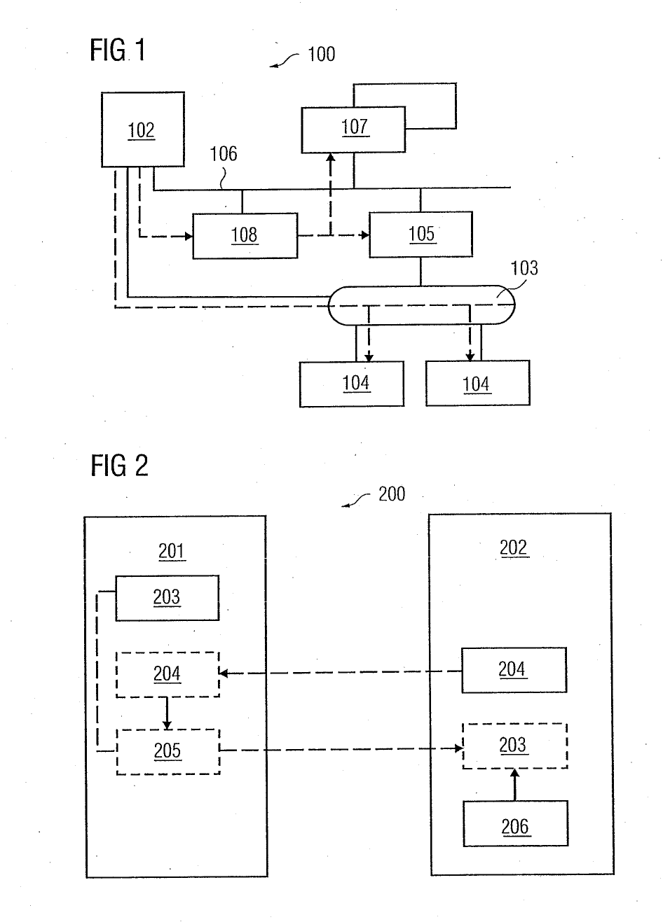

FIG. 1 illustrates a domain network 100, in which time synchronization is performed using a time clock 102. A plant communication bus 103 is configured for communication among the automation systems 104 and server 105. The automation system 104 can be a programmable logic controller (PLC). A terminal communication bus 106 is configured for the communication between the clients 107 and the server 105. The plant communication bus 103 is synchronized with the time clock 102. In alternative embodiments, the time clock 102 is a time server. A domain controller 108 is synchronized directly by the time clock 102, which further can synchronize all other domain members, such as the clients 107 and the server 105.

FIG. 2 illustrates a process flow diagram 200 between the client 201 and the time server 202 during time synchronization communication. The invention proposes a secured method for sending the public key 203 of the client 201 from the client 201 to a time server 202. The public key 203 of the client 201 is basically sent to the time server 202 for encrypting a response message to the client 201 as part of a time synchronization communication.

The time server 202 has a public key 204 as well as a private key 206. Before the time synchronization communication starts, the public key 204 of the time server 202 is shared with the client 201. The shared public key 204 of the time server is shown in the dotted box for explanation and understanding. Sharing the public key 204 of the time server 202 with the client 201 involves pre-installing the public key in the client prior to the time synchronization communication. In another embodiment, sharing the public key 204 of the time server 202 with the client 201 involves sending the public key 204 once by the time server 202 to the client 201 prior to the time synchronization communication. In yet another embodiment, sharing the public key 204 of the time server 202 with the client 201 involves providing the public key 204 from a secure store to the client 201, prior to the time synchronization communication.

The public key 203 of the client is encrypted to form an encrypted public key 205. The public key 203 of the client is encrypted using the public key 204 of the time server 202. The time server 202 decrypts the encrypted public key 205 of the client using the private key 206 of the time server 202. Now the client 201 has securely sent its public key 203 to the time server 202 as well as the time server 202 has the public key 203 of the client 201 for further communication.

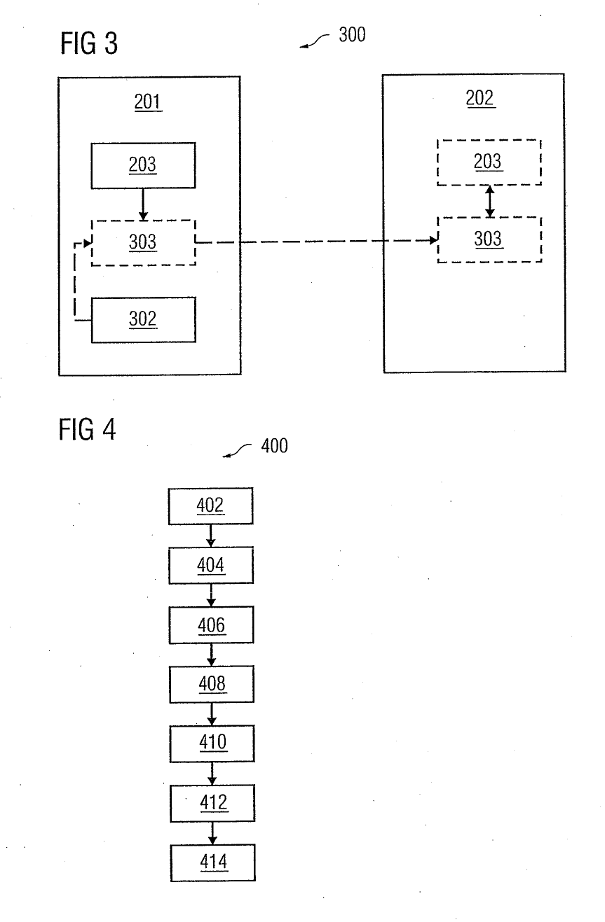

FIG. 3 illustrates a process flow diagram 300 between the client 201 and the time server 202 for additionally confirming the authenticity of the client 201 during time synchronization communication. This additional confirmation is in addition to the secured acquisition of the public key 203 of the client 201 by the time server 202 as explained in FIG. 2. This step can be made optional, but should be highly preferred for security reasons.

The public key 203 of the client 201 is signed using the private key 302 of the client 201 to form the signed public key 303. Then the signed public key 303 of the client, which is shown as the dotted box, is sent to the time server 202 by the client 201. Here, the public key 203 of the client, shown in dotted a box is already decrypted and kept in the time server 202. Accordingly, the time server 202 can easily verify the signed public key 303 of the client 201 using the public key 203 of the client 201 decrypted by the time server 202.

FIG. 4 is a flow chart 400 illustrating the time synchronization between a client and a time server in accordance with an embodiment of the invention using an NTP protocol. In accordance with the present embodiment, the secured communication discussed with respect to FIG. 2 and FIG. 3 can be implemented in a time synchronization communication protocol between a client and a time server, for example, the NTP protocol. The method for time synchronization communication between a client and a time server comprises sending a public key 203 from the client 201 to the time server 202 by the method explained with respect to FIG. 1 and FIG. 2, as indicated in step 402. Here, the sending of a public key 203 by a client 201 to a time server 202 occurs during a session key request. In accordance with the NTP protocol, the time sever 202, which might be an NTP server, sends a session key response message with a session key to the client 201 which might be an NTP client, as indicated in step 404. Here, the session key is encrypted using the public key 203 of the client and the encrypted session key is further signed with the private key 206 of the time server 202. An NTP header will have an extension field which consists of signature fields as well as value fields. For simplicity the detailed explanation of an NTP header with its entire associated fields are excluded in the description. The encrypted session key is packed in a value field associated with an NTP extension field of the NTP protocol. Further, the encrypted session key is signed and packed in a signature field associated with an NTP extension field of the NTP protocol.

Contrary to the above, during a session key request, if the client 201 sends its public key 203 information without any encryption but as simply plain data, then it is possible for the intruder to gain access to the plain data and create attacks during the session key request. The intruder can manipulate the client's public key 203 in the session key request packet. The intruder can then send the manipulated packet to the time server 202. The time server 202 will consider the session key request as a valid request, since data integrity is not affected. The time server 202 will send the session key response to the client 201. The time server 202 then generates a session key and encrypts it with the client's public key 203 which is actually a manipulated public key. The server will send the session key response to the client 201. The actual client 201 will receive the session key response, but the client 201 cannot decrypt the session key because the timeserver 202 has encrypted the session key with the manipulated public key of the client 201. The client 201 cannot proceed with a time request to the time server 202 without the session key. Hence, this leads to the stoppage/termination of communication and an obvious security violation. This is just one out of a multitude of possiblities of an intruder conducting a security threat.

The secured public key transfer described in accordance with the contemplated embodiments of the present invention does not enable the intruder to manipulate the public key 203 of the client 201 because the public key 203 is encrypted during the transfer. In accordance with the present embodiment, the client 201 verifies the signed session key using the public key 204 of the time server 202 and decrypts the session key using the private key 302 of the client 201, as indicated at step 406. The client 201 generates a secured hash value using the session key received by the client 201, as indicated at step 408. This hash value is used for a time request which the client 201 requests to the time server 202 for time synchronization.

The client 201 sends the time request message and the secured hash value to the time server 202, as indicated at step 410. The time server 202 verifies the time request message based on the secured hash value and the session key, as indicated at step 412. The secured hash value can be obtained using a hashing algorithm, such as a Message Digest (MD-5) algorithm. When the verification is performed correctly, then the time server 202 sends a time from the time server 202 to the client 202 for the time synchronization, as indicated in step 414.

Although the invention has been described with reference to specific embodiments, this description is not meant to be construed in a limiting sense. Various modifications of the 5 disclosed embodiments, as well as alternate embodiments of the invention, will become apparent to persons skilled in the art upon reference to the description of the invention. It is therefore contemplated that such modifications can be made without departing from the embodiments of the present invention as defined.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for sending a public key from a client to a time server for encrypting a response message to the client as part of a time synchronization communication, the method comprising:
providing a public key of the time server to the client independently of and prior to start of initiation of the time synchronization communication;
sending an encrypted public key of the client to the time server, a public key of the client being encrypted using the public key of the time server to form the encrypted public key; and
decrypting, at the time server, the encrypted public key of the client using a private key of the time server.

2. The method according to claim 1, wherein said step of providing the public key of the time server to the client comprises pre-installing the public key of the time server in the client prior to the time synchronization communication.

3. The method according to claim 1, wherein said step of providing the public key of the time server to the client comprises providing the public key of the time server from a secure store to the client, prior to the time synchronization communication.

4. The method according to claim 2, wherein said step of providing the public key of the time server to the client comprises providing the public key of the time server from a secure store to the client, prior to the time synchronization communication.

5. The method according to the claim 1, further comprising:
sending a signed public key of the client to the time server, the public key of the client being signed using a private key of the client to form the signed public key, and
verifying, at the time server, the signed public key of the client using the public key of the client decrypted by the time server.

6. The method according to claim 1, wherein an encrypted public key of the client is sent to the time server as part of a time synchronization communication according to a Network Time Protocol (NTP) standard, and wherein an encrypted public key of the client is included in a value field associated with an NTP extension field of an NTP header.

7. The method according to claim 5, wherein the signed public key of the client is sent to the time server as part of a time synchronization communication according to a Network Time Protocol (NTP) standard, and wherein the signed public key of the client is included in a signature field associated with an NTP extension field of an NTP header.

8. The method according to claim 1, wherein private keys and public keys of the time server and client are generated by a key generator.

9. A method for time synchronization communication between a client and a time server, comprising:
providing a public key of a time server to the client independently of and prior to start of initiation of the time synchronization communication;
sending an encrypted public key of the client to the time server, a public key of the client being encrypted using the public key of the time server to form the encrypted public key;
decrypting, at the time server, the encrypted public key of the client using a private key of the time server;
sending a session key response message with a session key by the time server to the client, the session key being encrypted using the public key of the client and further signed with the private key of the time server;
verifying, at the client, the signed session key using the public key of the time server and decrypting the session key using the private key of the client;
generating, at the client, a secured hash value for a time request using the session key received by the client;
sending the time request message and the secured hash value generated by the client to the time server;
verifying at the time server, the time request message based on the secured hash value and the session key; and
sending a time response from the time server to the client, the time response comprising information on a time for performing time synchronization.

10. The method according to claim 9, wherein an encrypted session key is sent to the client by the time server as part of a time synchronization communication in accordance with a Network Time Protocol (NTP) standard, and wherein the encrypted session key is included in a value field associated with an NTP extension field of NTP header.

11. The method according to claim 10, wherein the signed encrypted session key is sent to the client by the time server as part of a time synchronization communication in accordance with a Network Time Protocol (NTP) standard, and wherein the signed encrypted session key is included in a signature field associated with an NTP extension field of an NTP header.

12. The method according to claim 9, wherein the client is configured to send the time request message at a plurality of times to the time server for time synchronization during the time synchronization communication.

13. The method according to claim 9, wherein said step of providing the public key of the time server to the client comprises sending the public key by the time server to the client for a single time before sending the time request message by the client to the time server in a time synchronization communication.

14. The method according to claim 9, wherein private keys and public keys of the time server and client are generated by a key generator.
